(19) United States
(12) Patent Application Publication
(10) Pub. No.: US 2026/0071910 A1
(43) Pub. Date: Mar. 12, 2026

(54) Time-gated dual-comb sensing for long-distance high-resolution distributed fiber monitoring

(71) Applicant: NEC Laboratories America, Inc., Princeton, NJ (US)

(72) Inventors: Jian Fang, Princeton, NJ (US); Ting Wang, West Windsor, NJ (US)

(73) Assignee: NEC Laboratories America, Inc., Princeton, NJ (US)

(21) Appl. No.: 19/321,434

(22) Filed: Sep. 8, 2025

Related U.S. Application Data
(60) Provisional application No. 63/692,770, filed on Sep. 10, 2024.

(51) Int. Cl. G01H 9/00; G01D 5/353

(52) U.S. Cl. CPC G01H 9/004; G01D 5/35358

(57) ABSTRACT

A technique for dual-comb high-resolution distributed sensing that employs a “gating” feature to the probe comb in the time-domain. Operationally, probe comb signals are gated as blocks and sent into a optical fiber with adjusted time intervals. In a signal processing stage, the block signals are merged as a complete analysis window such that every spatial resolution can be reconstructed. By sliding the window, the entire optical fiber can advantageously be monitored. Our technique advantageously breaks a sensing distance bottleneck found in conventional, dual-comb distributed fiber sensing, thereby providing high-spatial resolution sensing over a long distance.

### CROSS REFERENCE TO RELATED APPLICATIONS

This application claims the benefit of U.S. Provisional Patent Application Ser. No. 63/692,770 filed Sep. 10, 2024, the entire contents of which is incorporated by reference as if set forth at length herein.

### FIELD OF THE INVENTION

This application relates generally to distributed fiber optic sensing (DFOS) and optical time-domain reflectometry (OTDR). More particularly, it pertains to time-gated dual-comb sensing for long distance high-resolution distributed fiber monitoring.

### BACKGROUND OF THE INVENTION

Dual-comb sensing, sometimes referred to as dual-comb spectroscopy (DCS), is known as a powerful tool for measuring the spectral properties of a substance due, in part, to its high-resolution and fast response. Recently, dual-comb sensing has also been applied to optical fiber sensing applications including high-resolution distributed strain monitoring-which is sometimes referred to by some as “time expansion”.

In conventional distributed fiber sensing approaches, achieving a high spatial resolution requires electronic components exhibiting a high bandwidth. For example, in a widely used optical time-domain reflectometry (OTDR) approach, a centimeter (cm)-scale spatial resolution requires very narrow optical pulses (˜100 picosecond), corresponding to at least a 10 GHz digital-to-analog converter (DAC) bandwidth which in turn requires expensive high-speed waveform generator instruments and/or field programmable gate arrays (FPGAs). An alternative approach—optical frequency-domain reflectometry (OFDR)—can also achieve cm-scale spatial resolution by sweeping a laser wavelength over a THz range. However, such broadband sweep/tunable lasers are typically bulky and expensive. Consequently, both approaches may not be practical nor cost-effective for many contemporary applications.

### SUMMARY OF THE INVENTION

An advance in the art is made according to aspects of the present disclosure directed to a novel technique for dual-comb high-resolution distributed sensing. In sharp to the prior art which sends a probe comb continuously, we employ a “gating” feature to the probe comb in the time-domain. According to aspects of the present disclosure, probe comb signals are gated as blocks and sent into the fiber with adjusted time intervals. In a signal processing stage, the block signals are merged as a complete analysis window such that every spatial resolution can be reconstructed. By sliding the window, the whole fiber can advantageously be monitored. Of further advantage, our inventive method according to the present disclosure breaks a sensing distance bottleneck found in conventional, dual-comb distributed fiber sensing, thereby providing a high-spatial resolution sensing over a long distance.

As those skilled in the art will understand and appreciate, particularly distinguishing aspects of techniques according to the present disclosure include at least the following; i) the time-gated blocks of the probe comb; ii) the adjusted time delays of the probe comb blocks that are directed into the optical fiber; iii) the unique signal processing stage that merges multiple blocks together and slides the window to scan the whole fiber; and iv) the capability to break sensing distance limitations of the prior art while improving the overall performance as compared thereto.

### BRIEF DESCRIPTION OF THE DRAWING

FIG. 1(A) and FIG. 1(B) are schematic diagrams showing an illustrative prior art uncoded and coded DFOS systems.

FIG. 2 is a schematic flow diagram showing illustrative comparison between our inventive time-gated dual-comb distributed sensing as compared with conventional, dual-comb distributed fiber sensing according to aspects of the present disclosure.

FIG. 3 is a schematic diagram showing illustrative conventional scheme for dual-comb distributed fiber sensing according to aspects of the present disclosure.

FIG. 4 is a schematic diagram showing an illustrative block structure of probe comb and local oscillator (LO) comb according to aspects of the present invention.

FIG. 5 shows the merging of time-gated blocks as a complete analysis window according to aspects of the present disclosure.

FIG. 6 is a schematic diagram showing the framework of time-gated distributed dual comb sensing according to aspects of the present invention.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

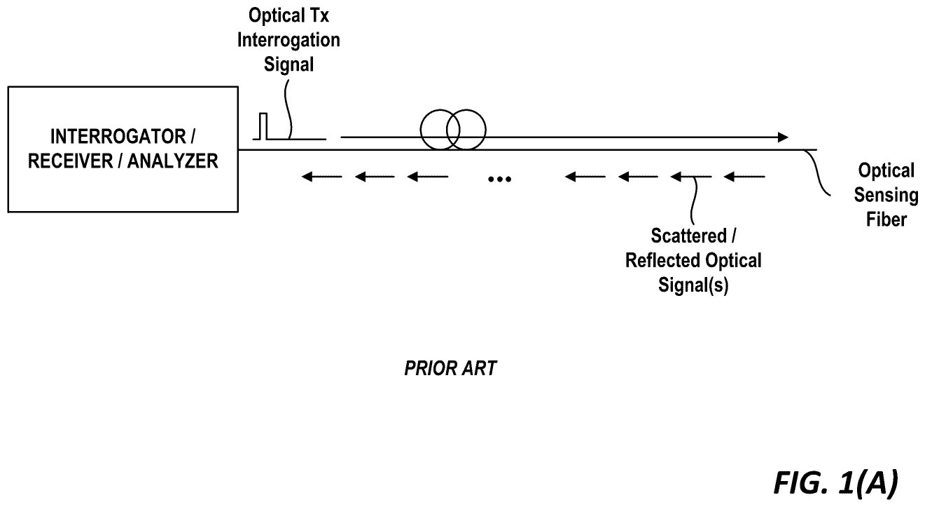

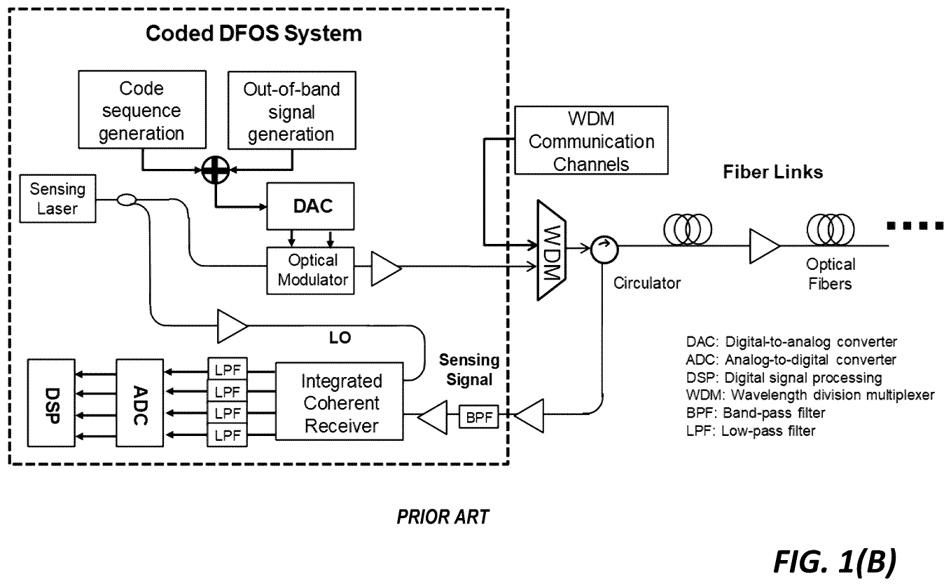

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

As is known, acoustic signals are produced by numerous events, enabling humans to naturally learn various types of sounds through acoustic sensory experiences. Therefore, acoustic signals are one of the essential factors for real-time awareness of surrounding events, as well as image and video data.

For example, the detection of an explosion sound by our ears can immediately indicate an anomaly. Deploying numerous audio sensors, like electric microphones, over large areas can provide valuable acoustic information for anomaly detection and scene or event recognition. However, this approach is energy-intensive, and these devices may require batteries to operate.

One solution to this issue is to use a distributed fiber-optic sensor. This DFOS technology advantageously converts an optical fiber extending over 10 kilometers into a distributed sensor with a spatial resolution on the order of 1 meter. Specifically—as noted above—a sensor employing phase-sensitive optical time-domain reflectometry (Phase-sensitive OTDR), also known as a Distributed Acoustic Sensor (DAS), can convert mechanical dynamic strains on the fiber, caused by acoustic signals, into phase changes in Rayleigh backscattered light. Consequently, this allows for the monitoring of local acoustic events over very large geographic areas using the optical fiber. Of further advantage, the optical fiber may be a telecommunications-carrying optical fiber, thereby allowing telecommunications traffic and DFOS—simultaneously.

As we have noted previously, dual-comb sensing, commonly referred to as dual-comb spectroscopy (DCS), is a powerful and advanced technique for measuring the spectral properties of a substance. It uses a pair of coherent laser sources called optical frequency combs.

As used herein, an optical frequency comb is a laser that produces a spectrum of light having a series of discrete, equally spaced spectral lines, or “teeth.” These teeth are extremely precise and stable in frequency. They can be thought of as a ruler for measuring light, with the teeth as the markings on the rule.

DCS works generally by interfering light from two optical frequency combs with slightly different repetition rates. When these two combs interact, they create a new signal in the radio frequency (RF) domain. This new signal, called an RF comb, contains all the spectral information of the original optical comb, but at much lower, more manageable frequencies. Characteristics of DCS include the following.
Two Combs, Different Rates: You have two frequency combs. One has a repetition rate of fr and the other has a slightly different repetition rate of fr+Δfr.
Interference: The light from these two combs is combined and passed through a sample (like a gas or liquid). The sample's absorption and phase shifts are encoded onto the light.
Heterodyne Detection: The combined light is then focused onto a single, fast photodetector. This detector performs a process called heterodyne detection, which essentially “beats” the two optical combs against each other
Frequency Mapping: This beating process down-converts the high-frequency optical signals into a much lower-frequency RF comb. Each pair of optical teeth (one from each comb) creates a unique beat note in the RF spectrum. The spacing of these RF teeth is precisely equal to the repetition rate difference, Δfr.

As those skilled in the art will readily understand and appreciate, dual-comb sensing offers significant advantages over conventional spectrometers.
High Resolution and Accuracy: Because the frequency of each comb tooth is precisely known and stabilized (often to an atomic clock), DCS can achieve extremely high spectral resolution and absolute frequency accuracy.
Broadband and Fast: It can simultaneously measure a very wide range of the spectrum (broadband) in a very short amount of time. This is because it collects data across all the comb teeth at once, unlike a traditional spectrometer that must scan through frequencies.
No Moving Parts: DCS uses a single photodetector and has no internal moving components like gratings or scanning mirrors. This makes the systems more robust, stable, and less susceptible to environmental disturbances.
High Sensitivity: The technique allows for long measurement paths, which is excellent for detecting trace gases or other weak signals.

Dual-comb sensing technique, as a novel research direction in recent decade, providing another cost-effective solution for high-spatial-resolution distributed fiber sensing. Dual-comb sensing employs a pair of optical frequency combs. One comb serves as a probe comb, which is sent into an optical fiber under test, while the other comb serves as a local oscillator (LO) comb which mixes with Rayleigh backscattering light from the probe comb in the fiber. Such probe-LO dual-comb sensing can achieve a centimeter-scale spatial resolution over a short distance.

Dual-comb sensing offers several advantages over conventional methods for distributed fiber sensing including:
High spatial resolution: dual-comb systems achieve high spatial resolution, typically in the centimeter range. This level of precision allows for detailed monitoring of structures and events along the entire length of the fiber.
Real-time monitoring: unlike some traditional methods that rely on time-consuming scanning or averaging techniques, dual-comb sensing provides real-time data acquisition. This capability is crucial for applications requiring rapid response or dynamic monitoring.
Simplified electronics: dual-comb systems use a single laser source split into two combs. This eliminates the need for complex electronics and synchronization mechanisms required by other methods. As a result, dual-comb sensing is more straightforward to implement.
Frequency-domain Information: dual-comb systems inherently provide frequency-domain information due to their comb structure. This can be advantageous for certain applications, such as identifying specific vibration frequencies or chemical species.
Multiplexing: Dual-comb sensing allows for multiplexing—simultaneous measurement of multiple physical parameters (e.g., strain, temperature, and acoustic waves) using a single fiber. Traditional methods often require separate sensors for each parameter.

However, the maximal sensing distance in dual-comb sensing is strictly limited by the repetition rate of the probe comb. For instance, if the repetition of the probe comb is 10 MHz, then the maximal sensing distance must not exceed 10 meters. In fact, key metrics, including maximum sensing distance, sensing speed, and spatial resolution, are bound together. What this means is that there is severe trade-off in conventional dual-comb sensing schemes.

For example, to achieve a 1 km sensing distance with a 2-cm spatial resolution, it is required to generate a pair of frequency combs with 5 GHz bandwidth, and 100 kHz spacing. Therefore, the sensing rate must be less than 1 Hz according to the theory. However, 1 Hz is not enough for most sensing applications. For 2-cm spatial resolution and 1 kHz sensing speed, the maximal sensing distance is only 3.16 meters, which is also not enough for a wide range of practical applications

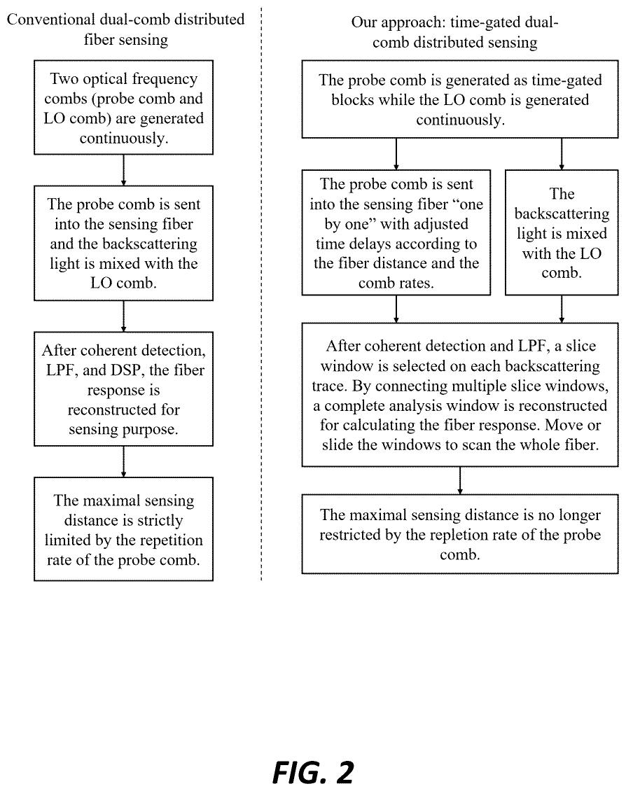

FIG. 2 is a schematic flow diagram showing illustrative comparison between our inventive time-gated dual-comb distributed sensing as compared with conventional, dual-comb distributed fiber sensing according to aspects of the present disclosure.

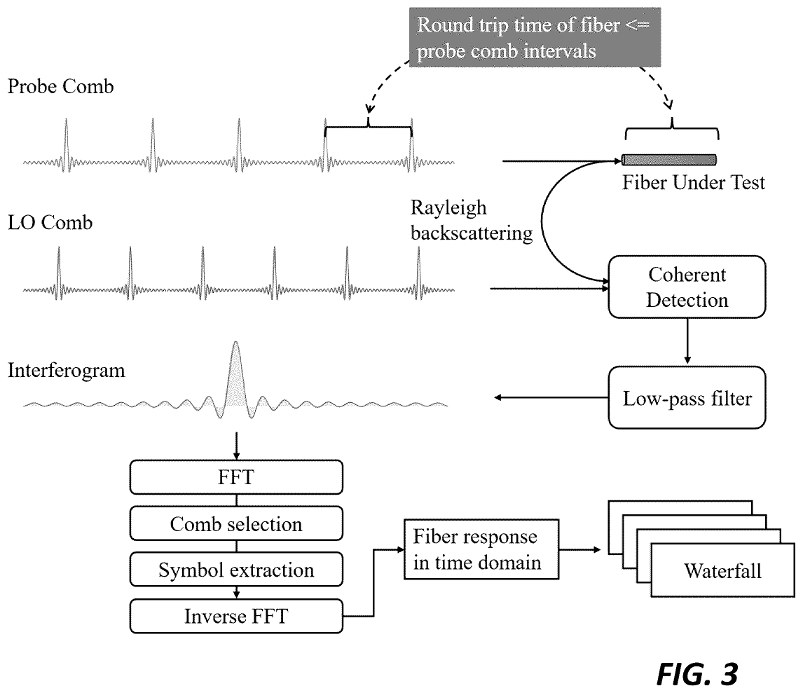

FIG. 3 is a schematic diagram showing illustrative conventional scheme for dual-domb distributed fiber sensing according to aspects of the present disclosure.

As we have noted and as illustratively shown in the figure, dual-comb distributed fiber sensing involves the use of two optical frequency combs: one serves as the probe comb and the other is employed as the LO. The probe comb and the LO comb typically have the same bandwidth B_{c}. One main difference is that their repetition rates in the time domain, which is also the comb spacing in the frequency domain, are slightly detuned.

For example, if the repetition rate of the probe comb is Δf₁, then LO comb's repetition rate will be Δf₂=Δf₁+δf, where δf is the detuning frequency between the two optical frequency combs. Like coherent OTDR, the probe comb is set into the fiber under test. The Rayleigh backscattering signal is returned and mixed with the LO comb through coherent detection.

There will be a few Nyquist zones in the heterodyne detection, while only the first Nyquist zone will be kept. After removing all the higher-order Nyquist zones via the low-pass filtering, the interferogram (IGM) will be obtained.

In the signal processing stage, the IGM will be first transformed into frequency domain through FFT. Then the comb lines are selected to extract the symbol. After the inverse FFT, the fiber response in time domain can be reconstructed. By repeating these steps, we can have the 2D pattern similar to the “waterfall” in the coherent OTDR. Any perturbation along the fiber could be measured and monitored in the waterfall data.

As those skilled in will understand and appreciate, there are a few fundamental trade-offs of dual-comb distributed fiber sensing.

First, the maximum length of the sensing fiber Lₘₐₓ is limited by the repetition rate of the probe comb. Recall that the repetition rate of the probe comb is Δf₁, Then the maximal sensing distance must not exceed c/(2nΔf₁), where c is the speed of light in vacuum and n is the fiber refractive index. The repetition rate in the time domain equals to the comb spacing in the frequency domain. Thus, the maximum sensing length is also limited by the comb spacing.

Additionally, the spatial resolution Δz is limited by the bandwidth of the probe comb and LO comb. Typically, the bandwidth of probe and LO combs (denoted as B_{c}) are remarkably close to each other. Therefore, the spatial resolution of dual-comb sensing is given by Δz=c/(2nB_{c}). Meanwhile, the number of individual effective sensor points should match the number of comb lines, i.e., N=Lₘₐₓ/Δz.

Finally, the sensing rate (or interrogating rate) fₛ is limited by the comb spacing (i.e., maximum sensing distance) and comb bandwidth (i.e., spatial resolution). In a conventional dual comb distributed sensing system, the sensing rate equals the frequency detuning (or frequency difference) 8f between two combs, i.e., fₛ=δf. To avoid aliasing in the DSP stage, the bandwidth of baseband interferogram must not exceed half of the comb bandwidth, indicating that i.e., Nfₛ≤Δf₁/2.

According to these fundamental limitations, for a given spatial resolution (Δz is fixed so B_{c} is also fixed), a longer sensing distance (Lₘₐₓ↑) requires smaller comb spacing (Δf₁↓), which corresponds to more comb lines (N↑) and lower sensing speed (fₛ↓). According to the theory, it seems to be possible to extend the sensing distance by simply reducing the comb spacing. However, there are more practical limitations including the following.

For a high-spatial resolution (such as 2 cm) the bandwidth needs to be at least 5 GHz. To cover a long distance (e.g., 1 km), the comb spacing needs to be 100 kHz. To date, there lacks a cost-effective approach to generate a 5 GHz bandwidth comb with 100 kHz spacing and high coherence. The conventional method employs high-speed instruments such as the Arbitrary Waveform Generators (AWGs) to modulate electrical frequency comb signals to the optical carrier. To generate the frequency comb for long distance, the instruments will be costly and bulky, which are not realistic for practical applications.

For long-distance dual comb sensing, it is required to generate a pair of frequency comb with >5 GHz bandwidth, <100 kHz spacing (for 1 km as an example). Therefore, the sensing rate must be less than 1 Hz according to the theory. However, 1 Hz is not enough for most sensing applications.

There is another technique called quasi-integer-ratio (QIR) scheme [R1] which employs two combs with an exceptionally large detuning frequency, i.e., a “slow” comb and a “fast” comb. Such a scheme could relax the trade-offs. However, it still requires bulky instruments and costly devices to generate such complicated comb pairs. In the signal processing stage, it needs to reorder the comb lines and have tight limitations, which lacks practical feasibility.

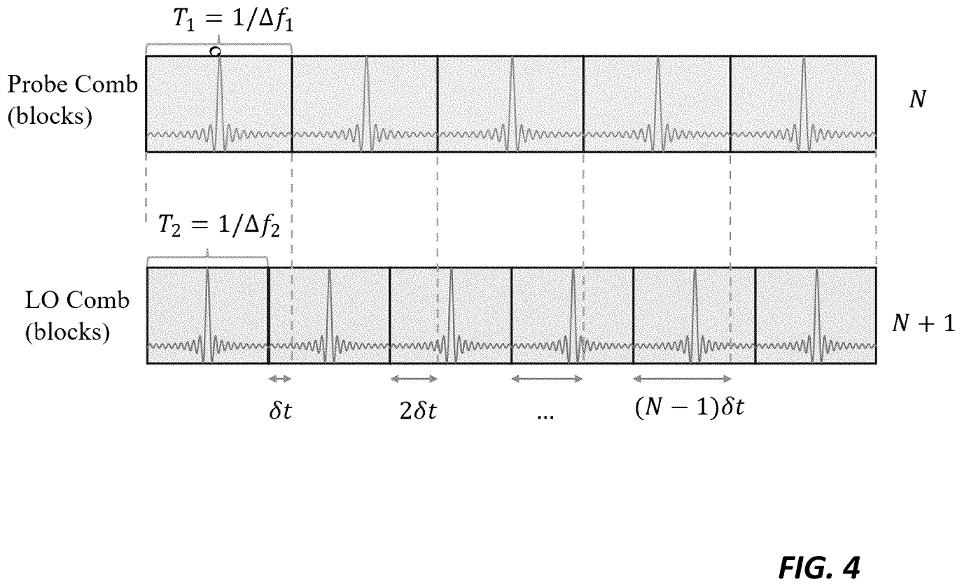

We solve these issues according to an aspect of the present disclosure directed to a novel technique we call time-gated dual comb sensing. With our inventive technique, the maximum sensing distance is no longer limited by the comb repetition rate. One particularly unique feature of our inventive technique is that we treat combs as a “block structure as schematically illustrated in FIG. 4, which is a schematic diagram showing an illustrative block structure of probe comb and local oscillator (LO) comb according to aspects of the present invention.

Recall that the repetition rates of the probe comb and LO comb are Δf₁ and Δf₂=Δf₁+δf, respectively. To obtain a complete interferogram in the analysis window, the total length of probe blocks and LO blocks need to be matched. Therefore, a minimal analysis window is typically set to 1/δf, in which that N probe blocks (i.e., N=Δf₁/δf) and N+1 LO blocks have the same length, as shown in FIG. 4.

Then from the block structure, we can find that there is a relative time shift between the end of each probe block and the LO block, which can be assigned as a vector d as:

$$d = [ 0 , δ t , 2 δ t , … , ( N - 1 ) δ t ] ,$$

$$δ t = {T}_{1} - {T}_{2} = \frac{1}{Δ {f}_{1}} - \frac{1}{Δ {f}_{2}} = \frac{{T}_{1}}{( N + 1 )} .$$

It is interesting to find that:

$$( N - 1 ) δ t + {T}_{1} = 2 {T}_{2} ,$$

which reveal the fact that the maximum time shift plus one probe comb block is exactly twice of the LO comb block.

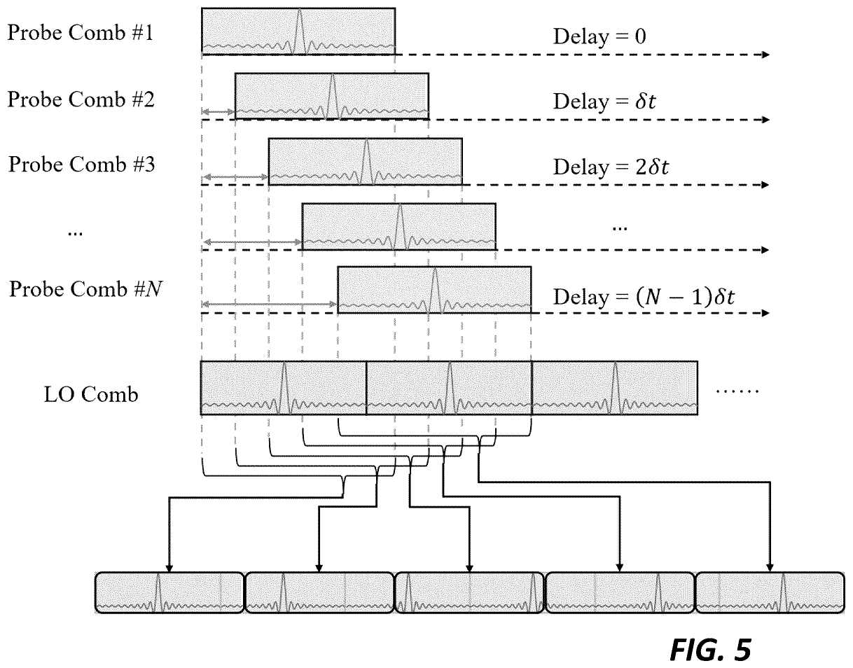

Based on this fact, our time-gated dual comb sensing method can be described as follows: Instead of sending all the blocks continuously, we send the probe comb block “one-by-one” into the fiber under test with adjusted time delays that match the delay vector d as defined above, as shown in FIG. 5, which shows the merging of time-gated blocks as a complete analysis window according to aspects of the present disclosure.

Each probe comb is gated (according to the comb's original repetition rate) so that it forms a single block. The LO comb is displayed as blocks, it is continuous without any gating. When these N delayed probe blocks interact with the LO combs, each delayed block will form a part of the complete analysis window. By connecting them end-to-end, we can merge them as a complete analysis window which is the same as the conventional dual-comb sensing technique.

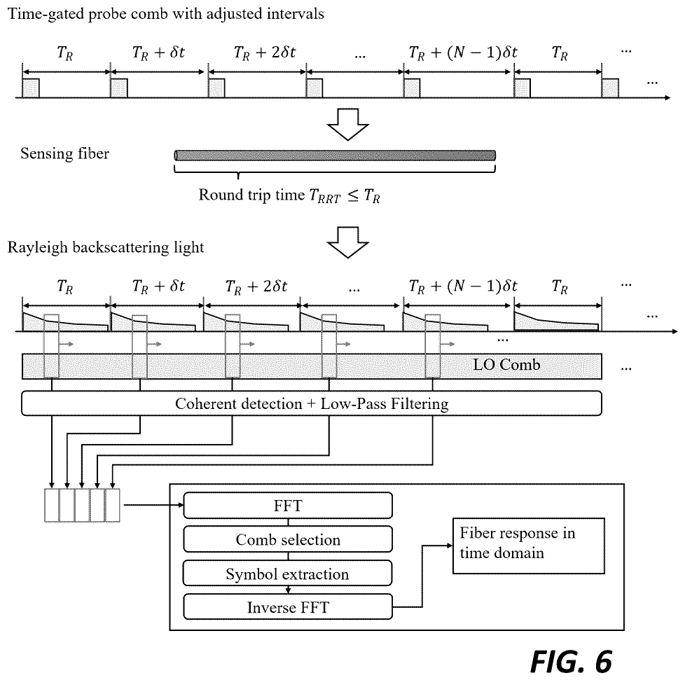

FIG. 6 is a schematic diagram showing the framework of time-gated distributed dual comb sensing according to aspects of the present invention.

FIG. 6 illustrates the principle of our proposed time-gated dual comb distributed sensing. In distributed fiber sensing, the probe blocks are sent into the fiber with a fixed time interval T_{R} plus the delay vector d. Like the OTDR, the T_{R} should be no less than the fiber round-trip time T_{RRT}. The trigger signals for ADC are placed at the start of each probe block. The probe comb after ideal “time-gating” (i.e., rectangular function) becomes:

$${E}_{c 1} ( t ) = {E}_{0} \cdot rect ( \frac{t}{{T}_{1}} ) \cdot exp [ - j 2 π {f}_{0} t ] \cdot [ {\sum }_{k = 1}^{N} {c}_{k} exp ( - j 2 π {f}_{k} t ) ] ,$$

where rect(t/T₁) is the rectangular function, E₀ and f₀ are the amplitude and frequency of the carrier light, T₁=1/Δf₁ is the duration of time gating, cₖ and fₖ are the complex spectral amplitude and frequency of the k-th comb line, respectively.

Typically, we have fₖ=k·Δf₁, k=1, 2, . . . , N. The Rayleigh scattering in the optical fiber can be modeled as massive, distributed scatterers. While the exact model is complicated, such a process could be simplified as a transfer function h(t). Therefore, the backscattering light is R_{c1}(t)=h(t)⊗E_{c1}(t). In the coherent detection, the beating signal from the backscattering light and LO comb (E_{c2}) is s(t)=R_{c1}(t). E_{c2}*(t). After the coherent detection and low-pass filtering, we have the beating signal mixed by the Rayleigh scattering and continuous LO comb blocks.

The key steps to reconstruct a complete analysis window are described as follows:
A) Starting from the trigger signal of N probe blocks, set a slice window to cut a piece of each data (the green box in FIG. 5). The length of the slice window equals the length of the time-gated probe block (i.e., T₁). Therefore, for the N probe blocks we have N data slices.
B) Combine these slice window data end-to-end to form a complete analysis window.
C) Perform the DSP stage (including FFT, comb selection, symbol extraction, and inverse FFT) to obtain the fiber response in the time domain.
D) Move or slide all windows simultaneously to the next location.
E) Repeat steps (B) and (C) to obtain a corresponding time domain response.
F) Combine all these time domain responses to form a complete response of the entire sensing fiber.

Each slice window corresponds to a fiber segment with a length of c/(2nΔf₁). The combining of N slice windows form a complete analysis window, which corresponds to N effective data points. Therefore, in each slice window, the spatial resolution will be c/(2nB_{c}).

It is found that in each slice window the fiber length and spatial resolution have the same expression as in the conventional dual comb sensing. However, the slice window can be narrow and the whole sensing distance can be “scanned” by sliding the window.

For instance, when Δf₁=50 MHz and B_{c}=5 GHz, the slice window is 2 m, the spatial resolution is 2 cm, and the total block number is N=1000. The LO comb rate is still limited by Nδf≤Δf₁/2, i.e., Δf₂=Δf₁+δf≤20.04 MHz. It means that we need 250 delayed probe blocks to merge as a complete analysis window.

Consider a typical 1 km sensing distance which corresponds to a round-trip time of ˜10 μs, 100 probe blocks corresponds to a sensing speed of 1 kHz, which is adequate for a wide range of applications. Compared with the 1 Hz sensing speed limited in the conventional dual-comb distributed fiber sensing, our method has 1000× times faster.

While we have presented our inventive concepts and description using specific examples, our invention is not so limited. Accordingly, the scope of our invention should be considered in view of the following claims.

1. A method for high-resolution distributed fiber sensing (DFOS) method comprising:
collecting, using a DFOS system, data from an optical sensing fiber; and
determining environmental conditions of the optical sensing fiber from the collected data;
wherein the method uses a time-gated dual comb sensing technique.

2. The method of claim 1, wherein the time-gated dual comb sensing technique comprises generating a probe optical frequency comb and a local oscillator (LO) optical frequency comb, wherein the probe comb is generated as time-gated blocks and the LO comb is continuous.

3. The method of claim 2, wherein the time-gated dual comb sensing technique comprises sending the time-gated probe comb blocks one-by-one into the optical sensing fiber with adjusted time delays.

4. The method of claim 3, further comprising, mixing backscattered light from the probe comb with the continuous LO comb.

5. The method of claim 4, further comprising, coherently detecting and low-pass filtering the mixed backscattered light and LO comb to obtain a backscatter trace.

6. The method of claim 5, further comprising, selecting a slice window of data from each backscatter trace, wherein a length of the slice window equals a duration of a time-gated probe block.

7. The method of claim 6, further comprising, combining the selected slice window using digital signal processing (DSP to reconstruct optical fiber response in the time domain.

8. The method of claim 7, further comprising, sliding the windows simultaneously to scan the entire length of the optical sensing fiber.

9. The method of claim 1, wherein time delays for the probe comb blocks are adjusted to match a delay vector, which is a function of repetition rates of the probe and LO combs.

10. A system for high-resolution distributed fiber sensing, comprising:
a probe comb generator configured to generate a probe optical frequency comb in time-gated blocks;
a local oscillator (LO) comb generator configured to generate a continuous LO optical frequency comb;
a sending mechanism configured to send the time-gated probe comb blocks into a sensing fiber with adjusted time delays; and
a receiver configured to mix backscattered light from the probe comb with the continuous LO comb.
